(19) United States
(12) Patent Application Publication
(10) Pub. No.: US 2012/0213100 A1
(43) Pub. Date: Aug. 23, 2012

(54) METHOD FOR SELECTING TRANSMISSION ARCHITECTURE AND TRANSMISSION SYSTEM

(75) Inventors: Ray-Guang Cheng, Keelung City (TW); Bo-Li Chang, Keelung City (TW)

(73) Assignee: National Taiwan University of Science and Technology, Taipei (TW)

(21) Appl. No.: 13/095,902

(22) Filed: Apr. 28, 2011

(30) Foreign Application Priority Data
Feb. 17, 2011 (TW) 100105270

(51) Int. Cl. H04W 4/06; H04W 24/10

(52) U.S. Cl. 370/252; 370/312

(57) ABSTRACT

A method for a transmission system selecting one of a plurality of transmission architectures to transmit a multicast-and-broadcast service is provided. The transmission system comprises at least one base station participating the transmission of the multicast-and-broadcast service. The method comprises recording a number of subscribers for subscribing the multicast-and-broadcast service within the coverage range of each of the base stations. According to the subscriber number and the number of the base stations, each of the transmission architectures is mapped to average cell efficiency. The average cell efficiency of each of the transmission architectures is analyzed. The transmission architecture corresponding to the maximum average cell efficiency is selected for the transmission system transmitting the multicast-and-broadcast service.

### CROSS-REFERENCE TO RELATED APPLICATION

This application claims the priority benefit of Taiwan application serial no. 100105270, filed Feb. 17, 2011. The entirety of the above-mentioned patent application is hereby incorporated by reference herein and made a part of this specification.

### BACKGROUND OF THE INVENTION

1. Field of Invention

The present invention relates to a method for selecting a transmission architecture and a transmission system. More particularly, the present invention relates to a method for dynamically selecting a transmission architecture and a transmission system according to a covering rages of base stations, coverage of base stations, subscriber distributions of base stations and numbers of subscribers of base stations.

2. Description of Related Art

IEEE 802.16 provides a concept of multicast-and-broadcast service (MBS) which is as same as the multimedia broadcast and multicast service (MBMS) provided by 3GPPLTE. Both of MBS and MBMS are the important service technologies in the fourth generation mobile communication system.

Generally, there are three major transmission types for transmitting multimedia service to multiple users, such as unicast, broadcast and multicast. The characteristic of the unicast is that a plurality of point-to-point transmission channels which are independent from each other are established between the network and the users for transmitting the service. However, when the data is transmitted to a lot of users, the a lot of bandwidth is consumed due to individual transmission. The characteristic of the broadcast is that the common point-to-multipoint transmission channel is established between the network and the users for transmitting the service and all of the users can receive the data. The characteristic of the multicast is that the common point-to-multipoint transmission channel is established between the network and the groups for transmitting the service. The multicast is different from the broadcast in that, in the multicast, only the user group subscribing the service receives the service.

The conventional multicast-and-broadcast service uses fixed transmission architecture. However, in the practical environment, the number of the subscribers in the covering range of the base station varies. The network resource cannot be effectively allocated by using the fixed transmission architecture.

### SUMMARY OF THE INVENTION

The invention provides a method for selecting a transmission architecture capable of improving the whole transmission performance of a transmission system transmitting a multicast-and-broadcast service.

The invention provides a transmission system capable of dynamically selecting transmission architecture according to covering ranges of base stations, coverage of base stations, subscriber distribution of base stations and the number of subscribers of the base stations so as to improve the whole transmission performance of a transmission system transmitting a multicast-and-broadcast service.

The invention provides a method for a transmission system selecting one of a plurality of transmission architectures to transmit a multicast-and-broadcast service. The transmission system includes at least a base station participating a transmission of the multicast-and-broadcast service. The method comprises steps of calculating a number of subscribers subscribing the multicast-and-broadcast service within a covering range of each of the base stations. According to a number of the base stations participating the transmission of the multicast-and-broadcast service, a coverage of each of the base stations, the covering range of each of the base stations, the number of the subscribers within the covering range of each of the base stations, a subscriber distribution of each of the base stations, an average cell efficiency corresponding to each of the transmission architectures which are respectively used by the transmission system to transmit the multicast-and-broadcast service is calculated. The average cell efficiency corresponding to each of the transmission architectures which are respectively used by the transmission system to transmit the multicast-and-broadcast service is analyzed. The transmission architecture corresponding to the maximum average cell efficiency is selected for the transmission system transmitting the multicast-and-broadcast service.

In one embodiment of the present invention, the average cell efficiency corresponding to each of the transmission architectures comprises an average cell information or an average cell spectral efficiency.

In one embodiment of the present invention, when the average cell efficiency corresponding to each of the transmission architectures is the average cell spectral efficiency, the step of calculating an average cell efficiency corresponding to each of the transmission architectures which are respectively used by the transmission system to transmit the multicast-and-broadcast service comprises steps of calculating a plurality of signal-to-interference-and-noise ratios (SINRs) corresponding to each of the base stations while the transmission system transmits the multicast-and-broadcast service respectively in each of the transmission architectures. According to the SINRs, a data per symbol corresponding to each of the base stations while the transmission system transmits the multicast-and-broadcast service respectively in each of the transmission architectures is determined. According to the data per symbol corresponding to each of the base stations as the transmission system transmits the multicast-and-broadcast service respectively in each of the transmission architectures, a single cell spectral efficiency of each of the base stations while the transmission system transmits the multicast-and-broadcast service respectively in each of the transmission architectures is calculated. According to the number of the base stations and the single cell spectral efficiency of each of the base stations while the transmission system transmits the multicast-and-broadcast service respectively in each of the transmission architectures, the average cell spectral efficiency corresponding to each of the transmission architectures in which the transmission system transmits the multicast-and-broadcast service respectively is calculated.

In one embodiment of the present invention, each of the transmission architectures is selected from a group comprised of a single-cell point-to-multipoint (SC-PTM) communication mode, a relay-enabled single-cell point-to-multipoint (relay-enabled SC-PTM) communication mode, a single frequency network (SFN) communication mode, a relay-enabled single frequency network (relay-enabled SFN) communication mode or the combination thereof.

In one embodiment of the present invention, after the step of calculating the number of the subscribers and before the step of calculating the average cell efficiency corresponding to each of the transmission architectures which are respectively used by the transmission system to transmit the multicast-and-broadcast service, the method further comprises a step of performing a preliminary selection, according to the number of the subscribers of each of the base stations, to select a portion of the transmission architectures, wherein, in the step of calculating the average cell efficiency, the average cell efficiency corresponding to each of the selected transmission architectures which are respectively used by the transmission system to transmit the multicast-and-broadcast service are calculated.

In one embodiment of the present invention, the preliminary selection comprises steps of classifying a communication mode of each of the base stations into communication classes including a SC-PTM communication class and a SFN communication class according to the number of the subscribers of each of the base stations. According to a preliminary transmission topology established by the communication class of each of the base stations in the transmission system, the portion of the transmission architectures which are similar to the preliminary transmission topology are selected.

The invention further provides a transmission system for transmitting a multicast-and-broadcast service. The transmission system comprises at least a base station participating a transmission of the multicast-and-broadcast service, a recording module, a calculating module, an analyzing module and a selecting module. The recording module records a number of subscribers subscribing the multicast-and-broadcast service within a covering range of each of the base stations. The calculating module calculates an average cell efficiency corresponding to each of the transmission architectures which are respectively used by the transmission system to transmit the multicast-and-broadcast service according to a number of the base stations participating the transmission of the multicast-and-broadcast service, a coverage of each of the base stations, the covering range of each of the base stations, the number of the subscribers within the covering range of each of the base stations, a subscriber distribution of each of the base stations. The analyzing module analyzes the average cell efficiency corresponding to each of the transmission architectures which are respectively used by the transmission system to transmit the multicast-and-broadcast service. The selecting module selects the transmission architecture corresponding to the maximum average cell efficiency for the transmission system transmitting the multicast-and-broadcast service.

In one embodiment of the present invention, the average cell efficiency corresponding to each of the transmission architectures comprises an average cell information or an average cell spectral efficiency.

In one embodiment of the present invention, when the average cell efficiency corresponding to each of the transmission architectures is the average cell spectral efficiency, the calculating module comprises an SINR calculating module, a determining module, a spectral efficiency calculating module and an average-value calculating module. The SINR calculating module calculates a plurality of signal-to-interference-and-noise ratios (SINRs) corresponding to each of the base stations while the transmission system transmits the multicast-and-broadcast service respectively in each of the transmission architectures. The determining module determines a data per symbol corresponding to each of the base stations according to the SINRs while the transmission system transmits the multicast-and-broadcast service respectively in each of the transmission architectures. The spectral efficiency calculating module calculates a single cell spectral efficiency of each of the base stations while the transmission system transmits the multicast-and-broadcast service respectively in each of the transmission architectures according to the data per symbol corresponding to each of the base stations as the transmission system transmits the multicast-and-broadcast service respectively in each of the transmission architectures. The average-value calculating module calculates the average cell spectral efficiency corresponding to each of the transmission architectures in which the transmission system respectively transmits the multicast-and-broadcast service according to the number of the base stations and the single cell spectral efficiency of each of the base stations while the transmission system transmits the multicast-and-broadcast service respectively in each of the transmission architectures.

In one embodiment of the present invention, each of the transmission architectures is selected from a group comprised of a single-cell point-to-multipoint (SC-PTM) communication mode, a relay-enabled single-cell point-to-multipoint (relay-enabled SC-PTM) communication mode, a single frequency network (SFN) communication mode, a relay-enabled single frequency network (relay-enabled SFN) communication mode or the combination thereof.

In one embodiment of the present invention, the transmission system further comprises a preliminary selection module selecting a portion of the transmission architectures according to the number of the subscribers of each of the base stations.

In one embodiment of the present invention, the preliminary selection module comprises a classifying module, a topology establishing module and a topology selection module. The classifying module classifies a communication mode of each of the base stations into communication classes including a SC-PTM communication class and a SFN communication class according to the number of the subscribers of each of the base stations. The topology establishing module establishes a preliminary transmission topology according to the communication class of each of the base stations in the transmission system. The topology selection module selects the portion of the transmission architectures which are similar to the preliminary transmission topology.

The invention provides a selection mechanism for selecting the transmission architecture for transmitting the multicast-and-broadcast service. In the selection mechanism of the present invention, the communication mode of each of the base stations is individually determined to improve the whole transmission performance of the transmission system. Moreover, by further considering the variables including the coverage of each of the base stations, the covering range of each of the base stations, the subscriber distribution of each of the base stations (probability of the distance between the subscriber and the base station) and the number of the subscribers of each of the base stations, several equations are provided to calculate the transmission efficiency respectively corresponding to each of the transmission architectures. Thus, the transmission architecture for transmitting the multicast-and-broadcast service can be dynamically changed by selecting the one with the maximum transmission efficiency.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a method for selecting a transmission architecture according to one embodiment of the present invention.

FIG. 2A is a schematic diagram showing a transmission topology of a transmission system only comprised of single-cell point-to-multipoint communication modes according to one embodiment of the present invention.

FIG. 2B is a schematic diagram showing a transmission topology of a transmission system which is a complex transmission architecture comprised of relay-enabled single-cell point-to-multipoint communication modes and single-cell point-to-multipoint communication modes according to one embodiment of the present invention.

FIG. 2C is a schematic diagram showing a transmission topology of a transmission system which is a complex transmission architecture comprised of single frequency network communication modes and a single-cell point-to-multipoint communication modes according to one embodiment of the present invention.

FIG. 2D is a schematic diagram showing a transmission topology of a transmission system which is a complex transmission architecture comprised of relay-enabled single frequency network communication modes and single-cell point-to-multipoint communication modes according to one embodiment of the present invention.

FIG. 3 is a flow chart illustrating a step of calculating an average cell efficiency corresponding to each of transmission architectures which are respectively used by a transmission system to transmit a multicast-and-broadcast service according to one embodiment of the present invention.

FIG. 4 is a flow chart illustrating a preliminary selection according to one embodiment of the present invention.

FIG. 5 is a plot diagram showing the average cell information changing with the variation of the numbers of subscribers at the coverage below 95% respectively in various transmission architectures.

FIG. 6 is a plot diagram showing the average cell spectral efficiency changing with the variation of the numbers of subscribers at the coverage below 95% respectively in various transmission architectures.

FIG. 7 is a schematic diagram showing a transmission system according to one embodiment of the present invention.

FIG. 8 is a schematic diagram showing a calculating module in a transmission system according to one embodiment of the present invention.

FIG. 9 is a schematic diagram showing a preliminary selection module in a transmission system according to one embodiment of the present invention.

### DESCRIPTION OF THE PREFERRED EMBODIMENTS

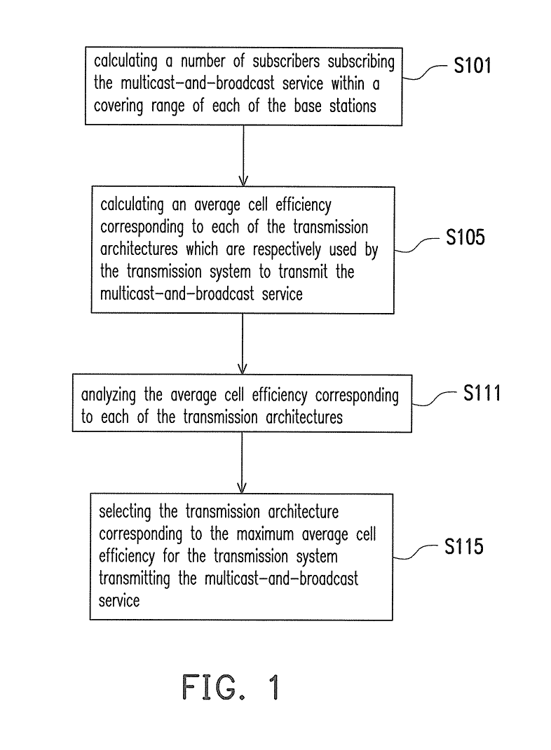

FIG. 1 is a flow chart illustrating a method for selecting a transmission architecture according to one embodiment of the present invention. As shown in FIG. 1, a method of selecting a transmission architecture of the present embodiment is used by a transmission system to select one of the transmission architectures to transmit a multicast-and-broadcast service. That is, before the transmission system transmits the multicast-and-broadcast service or during the transmission of the multicast-and-broadcast service, the transmission architecture used by the transmission system for transmitting the multicast-and-broadcast service can be dynamically changed. Moreover, the transmission system further comprises at least one base stations participating the transmission of the multicast-and-broadcast service. The transmission antenna of each of the base stations can be, for example, an omnidirectional antenna.

Each of the transmission architectures is selected from a group comprised of a single-cell point-to-multipoint (SC-PTM) communication mode, a relay-enabled single-cell point-to-multipoint (relay-enabled SC-PTM) communication mode, a single frequency network (SFN) communication mode, a relay-enabled single frequency network (relay-enabled SFN) communication mode or the combination thereof. That is, for the whole covering range of the transmission system, each of the transmission architectures can provides a transmission topology of the transmission system. Further, each of the transmission topologies reveals the distribution of the communication modes of the base stations in the transmission system.

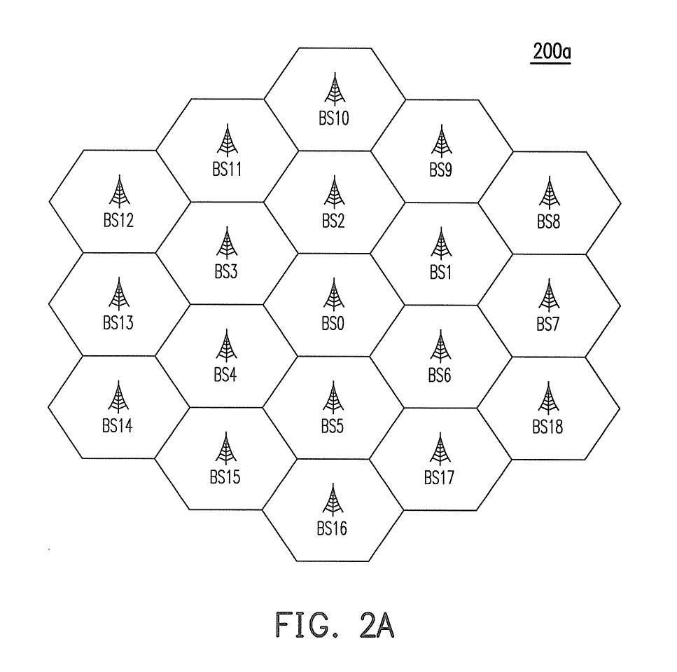

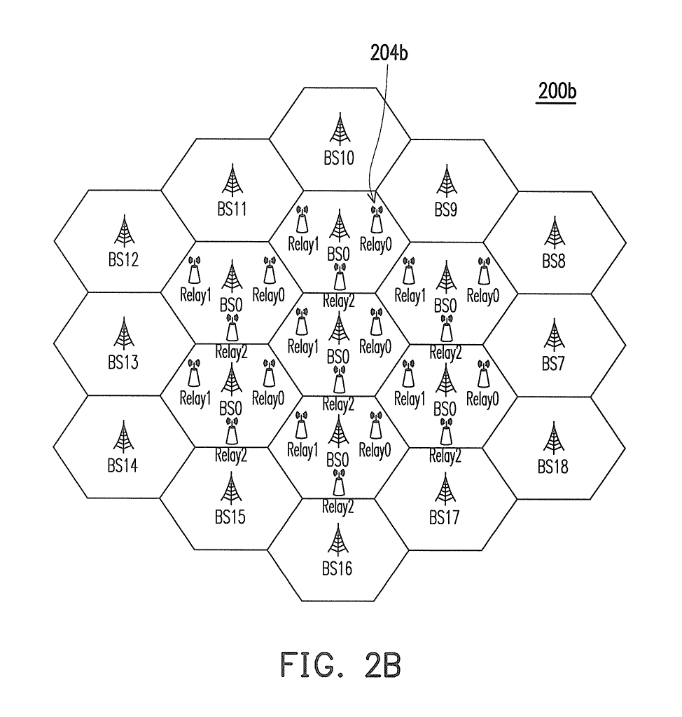

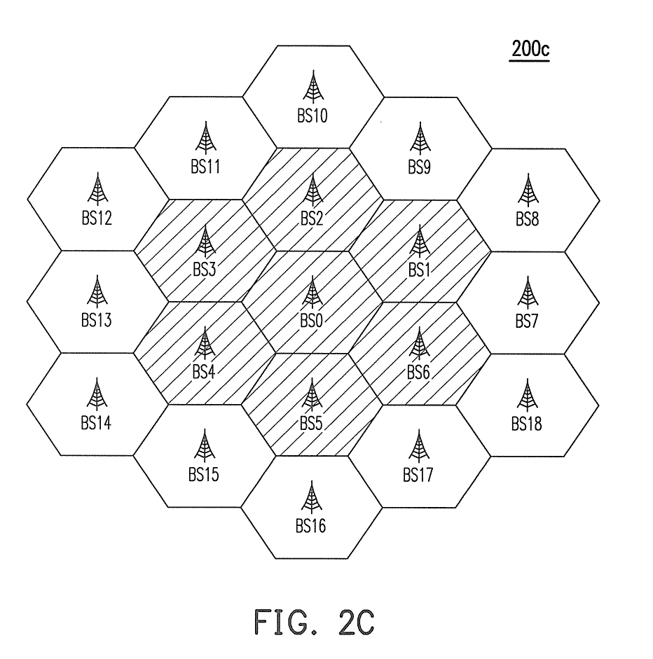

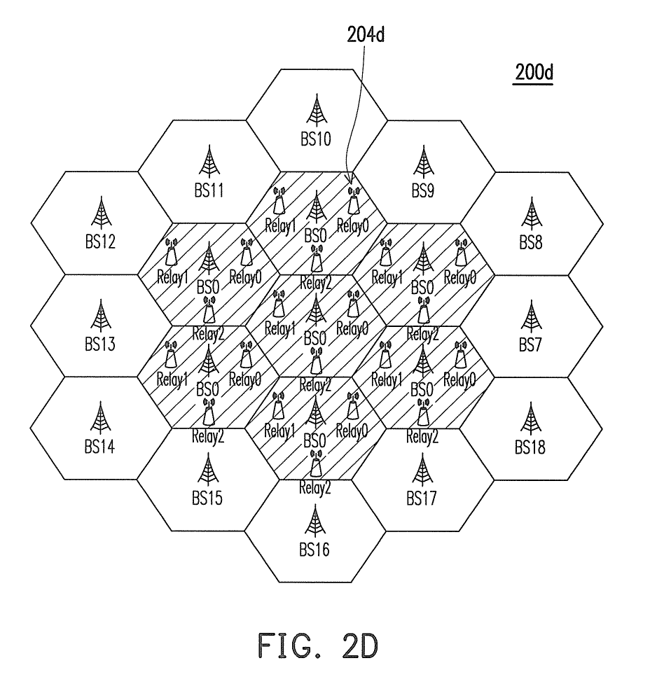

FIG. 2A is a schematic diagram showing a transmission topology of a transmission system only comprised of single-cell point-to-multipoint communication modes according to one embodiment of the present invention. As shown in FIG. 2A, the communication mode of each of the base stations (including base stations BS0˜BS18) in the transmission system 200a is the SC-PTM communication mode. FIG. 2B is a schematic diagram showing a transmission topology of a transmission system which is a complex transmission architecture comprised of relay-enabled single-cell point-to-multipoint communication modes and single-cell point-to-multipoint communication modes according to one embodiment of the present invention. As shown in FIG. 2B, in the transmission system 200b, all of the communication modes of the base stations (including base stations BS0˜BS6) located in the central region are the relay-enabled SC-PTM communication modes. On the other words, each of the base stations BS0˜BS6 respectively corresponds to several relay stations 204b so that, under the SC-PTM communication mode, the relay stations 204b are switched on to implement the relay transmission. Furthermore, the communication modes of the base stations (including the base stations BS7˜BS18) located in the peripheral region are the SC-PTM communication modes. FIG. 2C is a schematic diagram showing a transmission topology of a transmission system which is a complex transmission architecture comprised of single frequency network communication modes and single-cell point-to-multipoint communication modes according to one embodiment of the present invention. As shown in FIG. 2C, in the transmission system 200c, the communication modes of the base stations (including base stations BS0˜BS6) located in the central region are the SFN communication modes and the communication modes of the base stations (including the base stations BS7˜BS18) located in the peripheral region are the SC-PTM communication modes. FIG. 2D is a schematic diagram showing a transmission topology of a transmission system which is a complex transmission architecture comprised of relay-enabled single frequency network communication modes and single-cell point-to-multipoint communication modes according to one embodiment of the present invention. As shown in 2D, in the transmission system 200d, the communication modes of the base stations (including base stations BS0˜BS6) located in the central region are the relay-enabled SFN communication modes. That is, each of the base stations BS0˜BS6 respectively corresponds to several relay stations 204d so that, under the SFN communication mode, the relay stations 204d are switched on to implement the relay transmission. Moreover, the communication modes of the base stations (including the base stations BS7˜BS18) located in the peripheral region are the SC-PTM communication modes.

In addition, it should be noticed that in the relay-enabled SC-PTM communication mode and the relay-enabled SFN communication mode, one base station corresponds to several relay stations and each of the relay stations can be, for example, the relay station with the decode-and-forward type which decodes the received signals and forwards the decoded signals to the destination terminals.

Moreover, as shown in FIG. 1, in the step S101, the number of the subscribers who subscribe the multicast-and-broadcast service in a covering range of each of the base stations (i.e. the signal transmission covering range of the base station) is calculated.

Then, in the step S105, according to the number of the base stations participating the transmission of the multicast-and-broadcast service, a coverage of each of the base stations, the covering range of each of the base stations, the number of the subscribers within the covering range of each of the base stations, a subscriber distribution of each of the base stations, an average cell efficiency corresponding to each of the transmission architectures which are respectively used by the transmission system to transmit the multicast-and-broadcast service is calculated. The coverage is that, in the covering range of a single base station, the average block error rate of the packets or the signals of the broadcast service received by the subscribers located in the service quality guarantee range corresponding to the coverage must be smaller than the block error rate upper limit. For instance, in IEEE 802.16m standard, the performance of the multicast-and-broadcast service is evaluated by observing the maximum transmission rate while the block error rate of the packets received by the subscribers is smaller than 1% under the coverage of 95%. That is, the service quality is ensured within the coverage of 95%.

In the step S111, the average cell efficiency corresponding to each of the transmission architectures which are respectively used by the transmission system to transmit the multicast-and-broadcast service is analyzed. In the step S115, the transmission architecture corresponding to the maximum average cell efficiency is selected for the transmission system transmitting the multicast-and-broadcast service.

In the aforementioned embodiment, the average cell efficiency corresponding to each of the transmission architectures can be for example but not limited to, an average cell information (or the mutual information per cell) or an average cell spectral efficiency (or the spectral efficiency per cell). In the following embodiments, basing on the average cell information and the average cell spectral efficiency, the processes for evaluating the performance of the transmission system using each of the transmission architectures are described. Moreover, table 1 lists the definitions of the parameters used in the equations in the following embodiments.

TABLE 1

| parameters | Definitions |
|---|---|
| N | the number of the subscribers within a covering |
| | range of a single base station (single cell) |
| α | environmental variable |
| K | the total number of the base stations transmitting |
| | the constructive signals |
| J | the total number of the relay stations transmitting |
| | the constructive signals |
| M | the number of the interference sources transmitting |
| | the interference singles |
| R | radius of the covering range of the base station |
| C | ratio of the area of the service guarantee range to |
| | the area of the covering range of the base station |
| | (coverage of the base station) |
| X | the distance between the base station and the |
| | farthest subscriber within a covering range of a |
| | single base station |
| P_{Si} | the transmission power of the i-th base station |
| | among the base stations transmitting the |
| | constructive signals |
| P_{Im} | the transmission power of the m-th adjacent |
| | interference source |
| P_{Rij} | the transmission power of the j-th relay station |
| | corresponding to the i-th base station |
| ωᵢ | the weight factor of the transmission power of the |
| | i-th base station |
| ωᵢⱼ | the weight factor of the transmission power of the |
| | j-th relay station corresponding to the i-th base |
| | station |
| N_{D} | the noise at the receiving terminal |
| N_{Rij} | the noise of the signal transmitted to the j-th |
| | relay station corresponding to the i-th base station |
| d_{Si, FU} | the distance between the i-th base station and the |
| | farthest subscriber |
| d_{Rij, FU} | the distance between the j-th relay station |
| | corresponding to the i-th base station and the |
| | farthest subscriber |
| d_{Im, FU} | the distance between the m-th interference source to |
| | the farthest subscriber of the base station |
| d_{Si, Rij} | the distance between the i-th base station to the j-th |
| | relay station |
| d_{Im, Rij} | the distance between the m-th interference source to |
| | the j-th relay station corresponding to the i-th base |
| | station |
| d_{Si, CE} | the distance between the i-th base station to the border |
| | of the covering range of the i-th base station |
| d_{Rij, CE} | the distance between the j-th relay station |
| | corresponding to the i-th base station to the border of |
| | the covering range of the i-th base station |
| d_{Im, CE} | the distance between the m-th interference source to |
| | the border of the covering range of the base station |
| DL | the single cell spectral efficiency of the base station |
| DATA | the data per symbol which can be transmitted by the |
| | base station |
| N_{symbol/PRU} | the number of the symbols which can be carried by a |
| | physical resource unit |
| N_{PRU/frame} | the number of the physical resource units included in |
| | a frame |
| T_{DLservice/frame} | the transmission time of the downlink of each frame |
| BW | the total bandwidth |
| MCSₗₑᵥₑₗ(SINR_{X}) | the data per symbol while the distance between one of |
| | the subscribers and the base station is x |
| P(N, R, C, X) | the probability of portion or all of the subscribers |
| | located within a service guarantee range corresponding |
| | to the coverage |
| P(N, C) | the probability of all of the subscribers located |
| | between the border of the covering range and the |
| | service guarantee range |

### The Average Cell Information

Under the circumstance that the average cell information of the base stations in the transmission system is calculated to evaluate the performance of the transmission architectures, when the communication mode of a single base station in one transmission architecture is SFN communication mode, the distance between the border of the covering range of the base station and the base station is used as the basis of the calculation and the maximum transmission information (I_{SFN}) of the single base station in the SFN communication mode can be calculated according to equation (a):

$${I}_{SFN} = {log}_{2} ( 1 + \frac{{\sum }_{i = 1}^{K} \frac{{P}_{Si}}{{d}_{Si , CE}^{α}} {ω}_{i}}{{\sum }_{i = 1}^{K} \frac{{P}_{Si}}{{d}_{Si , CE}^{α}} ( 1 - {ω}_{i} ) + {\sum }_{m = 1}^{M} \frac{{P}_{Im}}{{d}_{Im , CE}^{α}} + {N}_{D}} ) \qquad ( a )$$

Moreover, when the communication mode of a single base station in one transmission architecture is relay-enabled SFN communication mode, the distance between the border of the covering range of the base station and the base station and the distance between the base station and the corresponding relay station are used as the bases of the calculation and the maximum transmission information (I_{SFN,RELAY}) of the single base station in the relay-enabled SFN communication mode can be calculated according to equation (b):

$${I}_{SFN , RELAY} = \frac{1}{2} min \{ \begin{matrix}{log}_{2} ( 1 + {\sum }_{i = 1}^{K} {\sum }_{j = 1}^{J} \frac{\frac{{P}_{Si}}{{d}_{si , Rij}^{α}}}{{\sum }_{m = 1}^{M} \frac{{P}_{Im}}{{d}_{Im , Rij}^{α}} + {N}_{Rij}} ) , \\ {log}_{2} ( 1 + \frac{{\sum }_{i = 1}^{K} ( \frac{{P}_{Si}}{{d}_{Si , CE}^{α}} {ω}_{i} + {\sum }_{j = 1}^{J} \frac{{P}_{Rij}}{{d}_{Rij , CE}^{α}} {ω}_{ij} )}{\begin{matrix}{\sum }_{i = 1}^{K} ( \begin{matrix}\frac{{P}_{Si}}{{d}_{Si , CE}^{α}} ( 1 - {ω}_{i} ) + \\ {\sum }_{j = 1}^{J} \frac{{P}_{Rij}}{{d}_{Rij , CE}^{α}} ( 1 - {ω}_{ij} )\end{matrix} ) + \\ {\sum }_{m = 1}^{M} \frac{{P}_{Im}}{{d}_{Im , CE}^{α}} + {N}_{Rij}\end{matrix}} )\end{matrix} \} \qquad ( b )$$

Further, when the communication mode of a single base station in one transmission architecture is SC-PTM communication mode, the maximum transmission information (I_{SC-PTM}) of the single base station in the SC-MTP communication mode can be calculated according to equation (c) by considering the parameters including the subscriber distribution in the covering rage of the single base station, the number of the subscribers and the various coverages:

$${I}_{SC \text{-} PTM} = {\int }_{0}^{\sqrt{ C} R} {log}_{2} ( 1 + \frac{\frac{{P}_{S 1}}{{X}^{α}}}{{\sum }_{m = 1}^{M} \frac{{P}_{Im}}{{d}_{Im , X}^{α}} + {N}_{D}} ) \times P ( N , R , C , X ) d X + {log}_{2} ( 1 + \frac{\frac{{P}_{S 1}}{{( \sqrt{C} R )}^{α}}}{{\sum }_{m = 1}^{M} \frac{{P}_{Im}}{{d}_{Im , \sqrt{C} R}^{α}} + {N}_{D}} ) \times P ( N , C ) \qquad ( c )$$

In addition, when the communication mode of a single base station in one transmission architecture is relay-enabled SC-PTM communication mode, the maximum transmission information (I_{SC-PTM,RELAY}) of the single base station in the SC-MTP communication mode can be calculated according to equation (d) by considering the parameters including the subscriber distribution in the covering rage of the single base station, the number of the subscribers and the various coverages:

$${I}_{SC \text{-} PTM , RELAY} = \frac{1}{2} min \{ \begin{matrix}{log}_{2} ( 1 + {\sum }_{j = 1}^{J} \frac{\frac{{P}_{S 1}}{{d}_{S 1 , R 1 j}}}{{\sum }_{m = 1}^{M} \frac{{P}_{Im}}{{d}_{Im , R 1 j}^{α}} + {N}_{R 1 j}} ) , \\ \begin{matrix}{\int }_{0}^{\sqrt{C} R} {log}_{2} ( 1 + \frac{\frac{{P}_{S 1}}{{d}_{S 1 , X}^{α}} + {\sum }_{j = 1}^{J} \frac{{P}_{R 1 j}}{{d}_{R 1 j , X}^{α}}}{{\sum }_{m = 1}^{M} \frac{{P}_{Im}}{{d}_{Im , R 1 j}^{α}} + {N}_{D}} ) \times \\ P ( N , R , C , X ) d X +\end{matrix} \\ {log}_{2} ( 1 + \frac{\frac{{P}_{S 1}}{{d}_{S 1 , \sqrt{C} R}^{α}} + {\sum }_{j = 1}^{J} \frac{{P}_{R 1 j}}{{d}_{R 1 j , \sqrt{C} R}^{α}}}{{\sum }_{m = 1}^{M} \frac{{P}_{Im}}{{d}_{Im , \sqrt{C} R}^{α}} + {N}_{D}} ) \times P ( N , C )\end{matrix} \} \qquad ( d )$$

It should be noticed that the probability P(N,R,C,X) can be obtained by applying equation (e):

$$P ( N , R , C , D ) = \frac{2 NX \times {[ ( 1 - C ) {R}^{2} + {X}^{2} ]}^{N - 1}}{{R}^{2 N}} X ∈ ( 0 , \sqrt{C} R ) \qquad ( e )$$

Also, the probability P(N,C) can be obtained by applying equation (f):

P(N,C)=(1−C)^{N} (f)

According to the transmission topology provided by each of the transmission architectures, the individual maximum transmission information of each of the base stations in different transmission architectures can be respectively calculated. Then, according to the number of the base stations participating the transmission of the multicast-and-broadcast service in the transmission system, the average cell information respectively corresponding to each of the transmission architectures used by the transmission system to transmit the multicast-and-broadcast service can be respectively calculated.

Taking the transmission topology shown in FIG. 2C as an exemplar, the transmission topology shown in FIG. 2C is a complex transmission architecture comprised of SFN communication modes and SC-PTM communication modes. There are seven base stations (including the base stations BS0˜BS6) in the central region and the communication mode of each of the base stations BS0˜BS6 is SFN communication mode. Also, there are twelve base stations (including the base stations BS7˜BS18) in the peripheral region and the communication mode of each of the base stations BS7˜BS18 is the SC-PTM communication mode. Therefore, the average cell information I_{average} corresponding to the transmission architecture shown in FIG. 2 used by the transmission system 200c to transmit the multicast-and-broadcast service can be calculated according to the equation (g):

$${I}_{average} = \frac{{I}_{SFN} \times 1 + {{\sum }_{BS = 7}}^{18} {( {I}_{SC \text{-} PTM} )}_{BS}}{1 + 12} \qquad ( g )$$

That is, the seven base stations operated in the SFN communication mode in the central region can be regarded as a single base station operated in the SFN communication mode. Further, the maximum transmission information I_{SFN} of the aforementioned single base station adds the sum of the maximum transmission information of the twelve base stations operated in the SC-PTM communication mode. Then, the summation is divided by the number of the base stations (which is 13) to obtain the average cell information of the transmission system 200c operated with the transmission architecture shown in FIG. 2C.

### The Average Cell Spectral Efficiency

When the average cell spectral efficiency of the base stations in the transmission system is calculated to evaluate the performance of the transmission architectures, the aforementioned step S105 for calculating the average cell efficiency corresponding to each of the transmission architectures which are respectively used by the transmission system to transmit the multicast-and-broadcast service is depicted in the following embodiments accompanied with the corresponding drawings.

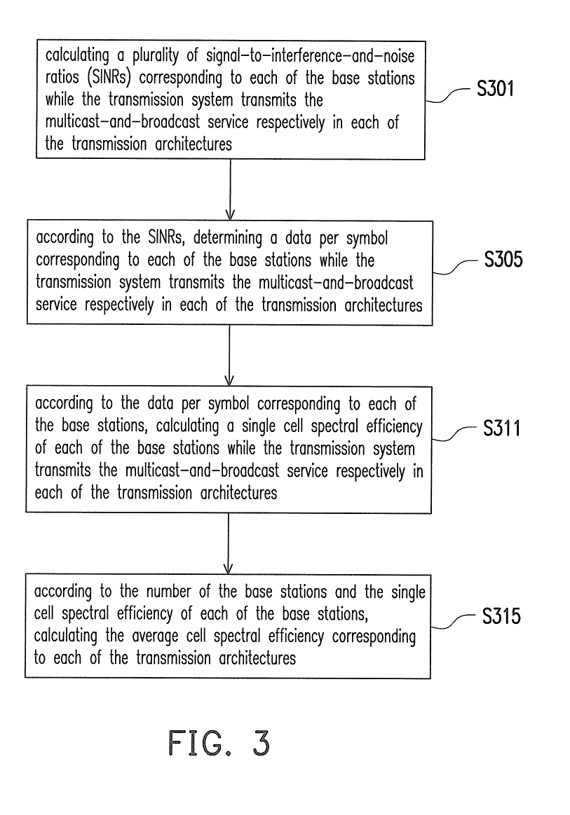

FIG. 3 is a flow chart illustrating a step of calculating an average cell efficiency corresponding to each of transmission architectures which are respectively used by a transmission system to transmit a multicast-and-broadcast service according to one embodiment of the present invention. As shown in FIG. 3, in the step S301, a plurality of signal-to-interference-and-noise ratios (SINRs) corresponding to each of the base stations while the transmission system transmits the multicast-and-broadcast service respectively in each of the transmission architectures are calculated.

In one embodiment, in a transmission topology provided by a transmission architecture, when the communication mode of a base station is the SC-PTM communication mode or the relay-enabled SC-PTM communication mode, the SINR of the multicast-and-broadcast service received by the farthest subscriber within the covering range of the base station is regarded as the SINR of the base station. Moreover, when the communication mode of a base station is the SFN communication mode or the relay-enabled SFN communication mode, the SINR of the multicast-and-broadcast service received by the subscriber at the border of the covering range of the base station is regarded as the SINR of the base station.

More specifically, when the communication mode of the base station is the SC-PTM communication mode, the SINR SINR_{SC-PTM} corresponding to the base station is calculated according to equation (h):

$${SINR}_{SC \text{-} PTM} = \frac{\frac{{P}_{S 1}}{{d}_{S 1 , FU}^{α}}}{{\sum }_{m = 1}^{M} \frac{{P}_{Im}}{{d}_{Im , FU}^{α}} + {N}_{D}} \qquad ( h )$$

When the communication mode of the base station is the relay-enabled SC-PTM communication mode, the SINR SINR_{SC-PTM,RELAY} corresponding to the base station is calculated according to equation (i):

$${SINR}_{SC \text{-} PRM , RELAY} = \frac{\frac{{P}_{S 1}}{{d}_{S 1 , FU}^{α} } + {\sum }_{j = 1}^{J} \frac{{P}_{ R 1 j}}{{d}_{R 1 j , FU}^{α}}}{{\sum }_{m = 1}^{M} \frac{{P}_{Im}}{{d}_{Im , FU}^{α}} + {N}_{D}} \qquad ( i )$$

When the communication mode of the base station is the SFN communication mode, the SINR SINR_{SFN} corresponding to the base station is calculated according to equation (j):

$${SINR}_{SFN} = \frac{{\sum }_{i = 1}^{K} \frac{{P}_{Si}}{{d}_{Si , CE }^{α}} {ω}_{i}}{{\sum }_{i = 1}^{K} \frac{{P}_{Si}}{{d}_{Si , CE }^{α}} ( 1 - {ω}_{i} ) + {\sum }_{m = 1}^{M} \frac{{P}_{Im}}{{d}_{Im , CE}^{α}} + {N}_{D}} \qquad ( j )$$

When the communication mode of the base station is the relay-enabled SFN communication mode, the SINR SINR_{SFN,RELAY} corresponding to the base station is calculated according to equation (k):

$${SINR}_{SFN , RELAY} = \frac{{\sum }_{i = 1}^{K} ( \frac{{P}_{Si}}{{d}_{Si , CE}^{α}} {ω}_{i} + {\sum }_{j = 1}^{J} \frac{{P}_{Rij}}{{d}_{Rij , CE}^{α}} {ω}_{ij} )}{\begin{matrix}{\sum }_{i = 1}^{K} ( \frac{{P}_{Si}}{{d}_{Si , CE}^{α}} ( 1 - {ω}_{i} ) + {\sum }_{j = 1}^{J} \frac{{P}_{Rij}}{{d}_{Rij , CE }^{α}} ( 1 - {ω}_{ij} ) ) + \\ {\sum }_{m = 1}^{M} \frac{{P}_{Im}}{{d}_{Im , CE}^{α}} + {N}_{D}\end{matrix}} \qquad ( k )$$

Thereafter, in the step S305, according to the SINRs corresponding to each of the base stations, a data per symbol corresponding to each of the base stations while the transmission system transmits the multicast-and-broadcast service respectively in each of the transmission architectures is calculated.

In one embodiment, the data per symbol corresponding to each of the base stations can be regarded as the function of SINR respectively corresponding to each of the base stations and the function of SINR is shown as equation (l):

DATA=MCSₗₑᵥₑₗ(SINR) (l)

By using table 2 to map SINR to modulation level and coding scheme, each of the SINRs calculated from the step S301 can be respectively mapped to the date per symbol corresponding to each of the base station.

TABLE 2

| | Modulation | Coding | | | |
|---|---|---|---|---|---|
| | level | scheme | SINR | | DATA |
| MCS₀ | QPSK | 2/15 | −4.97 | dB | 4/15 |
| MCS₁ | QPSK | 5/23 | −2.85 | dB | 10/23 |
| MCS₂ | QPSK | 10/29 | −0.84 | dB | 20/29 |
| MCS₃ | QPSK | 10/21 | 0.91 | dB | 20/21 |
| MCS₄ | QPSK | 11/18 | 2.52 | dB | 11/9 |
| MCS₅ | 16QAM | 6/19 | 3.98 | dB | 24/19 |
| MCS₆ | 16QAM | 5/12 | 5.40 | dB | 5/3 |
| MCS₇ | 16QAM | 16/33 | 6.56 | dB | 64/33 |
| MCS₈ | 16QAM | 5/9 | 7.52 | dB | 20/9 |
| MCS₉ | 16QAM | 5/8 | 8.61 | dB | 5/2 |
| MCS₁₀ | 16QAM | 5/7 | 9.94 | dB | 20/7 |
| MCS₁₁ | 64QAM | 1/2 | 11.56 | dB | 3 |
| MCS₁₂ | 64QAM | 11/18 | 13.19 | dB | 11/3 |
| MCS₁₃ | 64QAM | 19/27 | 14.94 | dB | 38/9 |
| MCS₁₄ | 64QAM | 4/5 | 16.64 | dB | 24/5 |
| MCS₁₅ | 64QAM | 19/21 | 18.94 | dB | 38/7 |

In the step S311, according to the data per symbol corresponding to each of the base stations as the transmission system transmits the multicast-and-broadcast service respectively in each of the transmission architectures, the single cell spectral efficiency of each of the base stations while the transmission system transmits the multicast-and-broadcast service respectively in each of the transmission architectures is calculated.

In one embodiment, in each of the transmission architectures, the single cell spectral efficiency DL of each of the base stations can be calculated according to equation (m):

$$DL = \frac{DATA \times {N}_{symbol / PRU} \times {N}_{PRU / frame}}{{T}_{DLservice / frame} \times BW} \qquad ( m )$$

In the step S415, according to the number of the base stations and the single cell spectral efficiency of each of the base stations while the transmission system transmits the multicast-and-broadcast service respectively in each of the transmission architectures, the average cell spectral efficiency corresponding to each of the transmission architectures in which the transmission system transmits the multicast-and-broadcast service respectively is calculated.

Taking the transmission topology shown in FIG. 2C as an exemplar, the transmission topology shown in FIG. 2C is a complex transmission architecture comprised of SFN communication modes and SC-PTM communication modes. There are seven base stations (including the base stations BS0˜BS6) in the central region and the communication mode of each of the base stations BS0˜BS6 is SFN communication mode. Also, there are twelve base stations (including the base stations BS7˜BS18) in the peripheral region and the communication mode of each of the base stations BS7˜BS18 is the SC-PTM communication mode. Therefore, the average cell spectral efficiency DL_{average} corresponding to the transmission architecture shown in FIG. 2 used by the transmission system 200c to transmit the multicast-and-broadcast service can be calculated according to the equation (n):

$${DL}_{average} = \frac{{DL}_{SFN} \times 1 + {\sum }_{BS = 7}^{18} {( {DL}_{SC \text{-} PTM} )}_{BS}}{1 + 12} \qquad ( n )$$

That is, the seven base stations operated in the SFN communication mode in the central region can be regarded as a single base station operated in the SFN communication mode. Further, the cell spectral efficiency DL_{SFN} of the aforementioned single base station adds the sum of the cell spectral efficiencies of the twelve base stations operated in the SC-PTM communication mode. Then, the summation is divided by the number of the base stations (which is 13) to obtain the average cell spectral efficiency of the transmission system 200c operated with the transmission architecture shown in FIG. 2C.

In another embodiment, by considering the covering rage of each of the base stations, the subscriber distribution within the covering range of each of the base stations, the number of the subscribers of each of the base stations and various coverages, in the aforementioned step S105 for calculating the average cell efficiency (average cell spectral efficiency) corresponding to each of the transmission architectures used by the transmission system to transmit the multicast-and-broadcast service, when the communication mode of the base station is the SC-PTM communication mode or the relay-enabled SC-PTM communication mode, the data per symbol of the farthest subscriber with various farthest distance away from the base station can be calculated by using equation (I) and then the single cell spectral efficiency DL within the covering range of the base station can be calculated by using equation (o):

$$DL = {\int }_{0}^{\sqrt{C} R} \frac{{MCS}_{level} ( {SINR}_{X} ) \times {N}_{symbol / PRU} \times {N}_{PRU / frame}}{{T}_{DLservice , frame} \times BW} \times P ( N , R , C , X ) d X + \frac{{MCS}_{level} ( {SINR}_{\sqrt{C} R} ) \times {N}_{symbol / PRU} \times {N}_{PRU / frame}}{{T}_{DLservice / frame} \times BW} \times P ( N , C ) \qquad ( o )$$

When the communication mode of the base station is the SFN communication mode or the relay-enabled SFN communication mode, the SINR of the multicast-and-broadcast service received by the subscriber located at the border of the covering range of the base station is calculated. Further, according to the obtained SINR and the aforementioned equation (m), the single cell spectral efficiency DL of the base station corresponding to the transmission architecture while the transmission system transmits the multicast-and-broadcast service with the transmission architecture is calculated.

Similar to the aforementioned step S415, according to the number of the base stations participating the transmission of the multicast-and-broadcast service in the transmission system and the single cell spectral efficiency of each of the base stations while the transmission system transmits the multicast-and-broadcast service respectively in each of the transmission architectures, the average cell spectral efficiency corresponding to each of the transmission architectures in which the transmission system transmits the multicast-and-broadcast service respectively is calculated.

In the other embodiment, after the step (S101) of calculating the number of the subscribers of each of the base stations and before the step (S105) of calculating the average cell efficiency corresponding to each of the transmission architectures, the method for the transmission system to select a transmission architecture further comprises a step of performing a preliminary selection to select a portion of the transmission architectures according to the number of the subscribers of each of the base stations. In the step of calculating the average cell efficiency, the average cell efficiency corresponding to each of the selected transmission architectures which are respectively used by the transmission system to transmit the multicast-and-broadcast service are calculated.

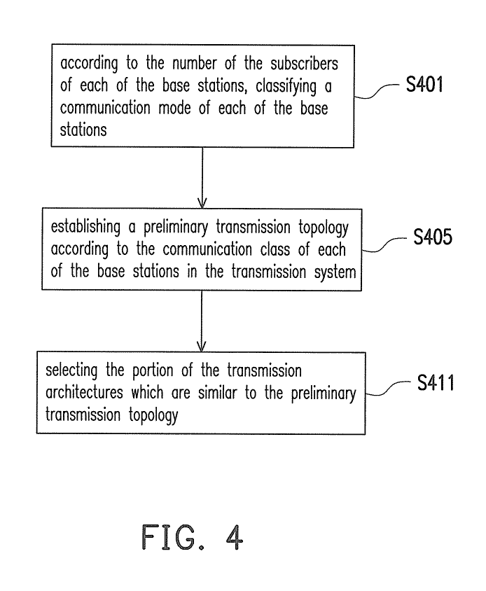

FIG. 4 is a flow chart illustrating a preliminary selection according to one embodiment of the present invention. More specifically, as shown in FIG. 4, in the step S401, the communication modes of each of the base stations is classified into communication classes including a SC-PTM communication class (including the SC-PTM communication mode and the relay-enabled SC-PTM communication mode) and a SFN communication class (including the SFN communication mode and the relay-enabled SFN communication mode) in advance according to the number of the subscribers of each of the base stations.

In the step S405, a preliminary transmission topology established according to the communication class of each of the base stations in the transmission system. In the step S411, according to the preliminary transmission topology, the portion of the transmission architectures similar to the preliminary transmission topology are selected. More specifically, when the number of the subscribers of the base station is larger than seven, the communication mode of the base station is classified into the SFN communication class. However, when the number of the subscribers of the base station is smaller than seven, the communication mode of the base station is classified into the SC-PTM communication class.

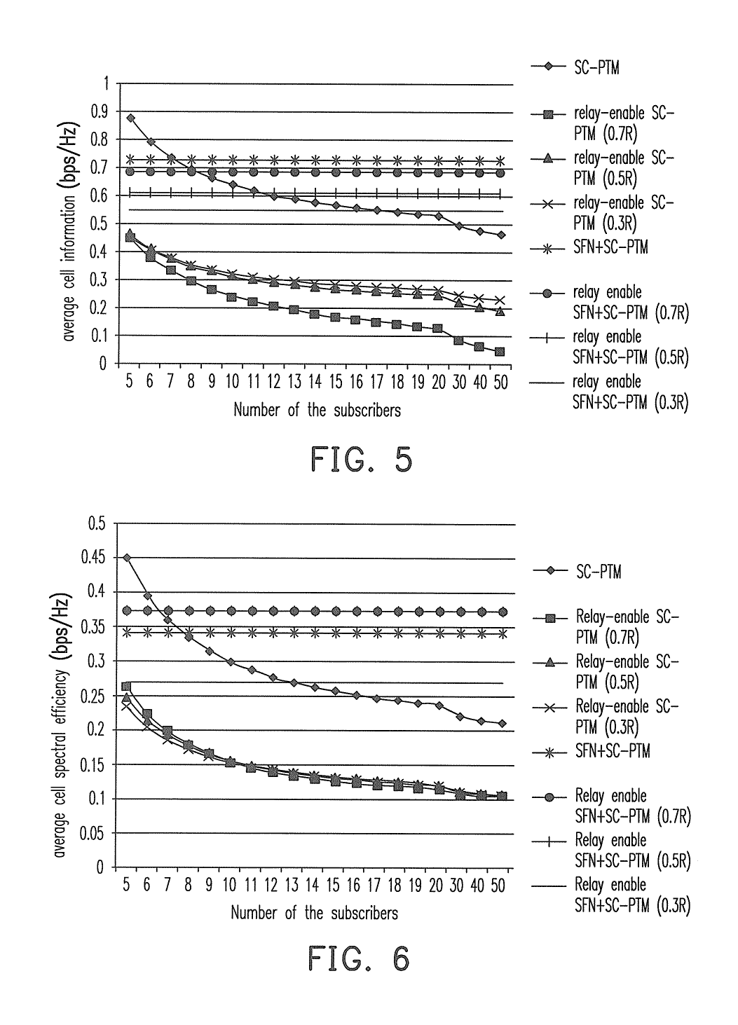

FIG. 5 is a plot diagram showing the average cell information changing with the variation of the numbers of subscribers at the coverage below 95% respectively in various transmission architectures. FIG. 6 is a plot diagram showing the average cell spectral efficiency changing with the variation of the numbers of subscribers at the coverage below 95% respectively in various transmission architectures. FIG. 5 and FIG. 6 respectively show the variation of the average cell information and the variation of the average cell spectral efficiency which are calculated under the same circumstance that the relay stations are located in different positions (the distance between the base station and the relay station is 0.3, 0.5 or 0.7 of the radius of the covering range). As shown in FIG. 5 and FIG. 6, under different transmission architectures, the average cell information varied with the increasing of the number of the subscribers is similar to the average cell spectral efficiency varied with the increasing of the number of the subscribers. Moreover, for each of the base stations operated in the SC-PTM communication mode and in relay-enabled SC-PTM communication mode, the average cell information and the average cell spectral efficiency are decreased with the increasing of the number of the subscribers. Further, when the number of the subscribers is around 5˜10, the selection of the transmission architecture can be selected by mainly considering the average cell spectral efficiency with the assistance of the average cell information.

In addition, when the number of the subscribers within the covering range is relatively large, the base stations operated in the SFN communication mode and relay-enabled SFN communication mode reveal relatively better performances. On the other hand, when the number of the subscribers within the covering range is relatively small, the base stations operated in the SC-PTM communication mode and relay-enabled SC-PTM communication mode reveal relatively better performances. For instance, as shown in FIG. 6, when the number of the subscribers in the covering range of the base station is smaller than seven, the transmission system operated with the transmission architecture only comprised of SC-PTM communication modes reveals a relatively better average cell spectral efficiency. However, when the number of the subscribers in the covering range of the base station is larger than or equal to seven, the transmission system operated with the complex transmission architecture comprised of the SFN communication modes and the SC-PTM communication modes reveals a relatively better average cell spectral efficiency.

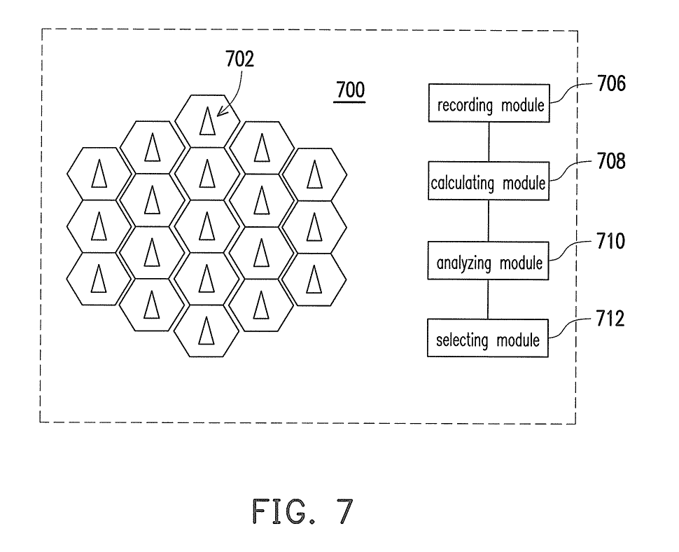

FIG. 7 is a schematic diagram showing a transmission system according to one embodiment of the present invention. As shown in FIG. 7, in the present embodiment, the transmission system 700 implements the aforementioned method for selecting one of the transmission architectures to transmit the multicast-and-broadcast service. That is, before the transmission system 700 transmits the multicast-and-broadcast service or during the transmission of the multicast-and-broadcast service, the transmission architecture used by the transmission system for transmitting the multicast-and-broadcast service can be dynamically changed. The definition of the transmission architecture is described in the embodiment mentioned above and is not depicted herein.

As shown in FIG. 7, the transmission system 700 comprises at least a base station 702 participating a transmission of the multicast-and-broadcast service, a recording module 706, a calculating module 708, an analyzing module 710 and a selecting module 712. The transmission antenna of each of the base stations can be, for example, an omnidirectional antenna. The recording module 706 calculates and records a number of subscribers subscribing the multicast-and-broadcast service within a covering range of each of the base stations (the step S101 in the previous embodiment).

According to a number of the base stations participating the transmission of the multicast-and-broadcast service in the transmission system 700, a coverage of each of the base stations, the covering range of each of the base stations, the number of the subscribers within the covering range of each of the base stations, a subscriber distribution of each of the base stations, the calculating module 708 calculates an average cell efficiency corresponding to each of the transmission architectures which are respectively used by the transmission system 700 (step S105).

The analyzing module 710 analyzes the average cell efficiency corresponding to each of the transmission architectures which are respectively used by the transmission system 700 to transmit the multicast-and-broadcast service (step S111). The selecting module 712 selects the transmission architecture corresponding to the maximum average cell efficiency for the transmission system 700 transmitting the multicast-and-broadcast service (step S115). In the above embodiment, the average cell efficiency respectively corresponding to each of the transmission architectures can be, for example but not limited to, an average cell information (or the mutual information per cell) or an average cell spectral efficiency (or the spectral efficiency per cell).

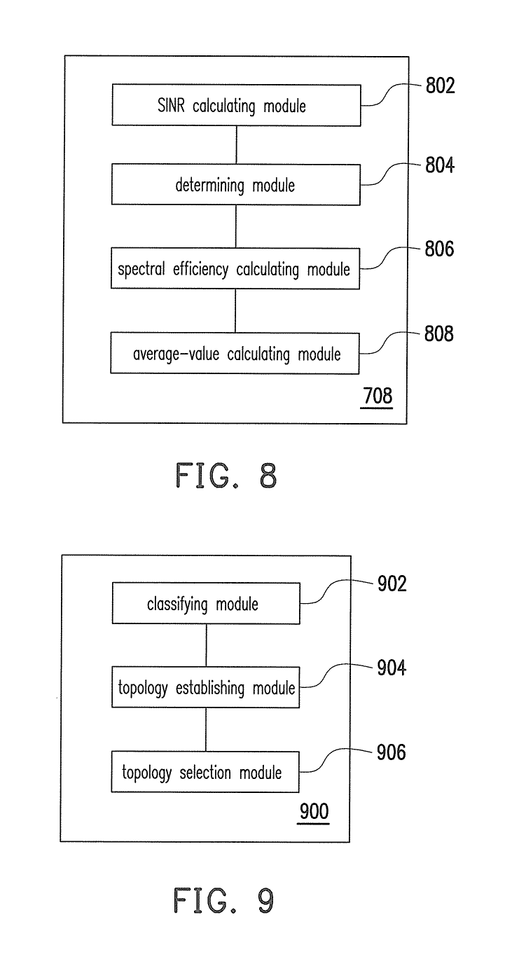

FIG. 8 is a schematic diagram showing a calculating module in a transmission system according to one embodiment of the present invention. When the average cell spectral efficiency is used as an standard to evaluate the performance of the transmission system operated with the transmission architecture, the calculating module 708 of the transmission system 700 in FIG. 7 further comprise an SINR calculating module 802, a determining module 804, a spectral efficiency calculating module 806 and an average-value calculating module 808.

The SINR calculating module 802 calculates a plurality of signal-to-interference-and-noise ratios (SINRs) respectively corresponding to each of the base stations while the transmission system 700 transmits the multicast-and-broadcast service respectively in each of the transmission architectures (step S301 in the previous embodiment).

In one embodiment, under a transmission topology provided by a transmission architecture, when a base station is operated in the SC-PTM communication mode or the relay-enabled SC-PTM communication mode, the SINR calculating module 802 calculates the SINR of the multicast-and-broadcast service received by the farthest subscriber away from the base station and within the covering range of the base station. Moreover, when the base station is operated in the SFN communication mode or relay-enabled SFN communication mode, the SINR calculating module 802 calculates the SINR of the multicast-and-broadcast service received by one of the subscribers at the border of the covering range.

More specifically, when the base station is operated in the SC-PTM communication mode, the SINR calculating module 802 calculates the SINR SINR_{SC-PTM} corresponding to the base station according to the equation (h) mentioned above.

When the base station is operated in the relay-enabled SC-PTM, the SINR calculating module 802 calculates the SINR SINR_{SC-PTM,RELAY} corresponding to the base station according to the equation (i) mentioned above.

When the base station is operated in the SFN, the SINR calculating module 802 calculates the SINR SINR_{SFN} corresponding to the base station according to the equation (j) mentioned above.

When the base station is operated in the relay-enabled SFN, the SINR calculating module 802 calculates the SINR SINR_{SFN,RELAY} corresponding to the base station according to the equation (k) mentioned above.

The determining module 804 determines a data per symbol corresponding to each of the base stations according to the SINRs while the transmission system transmits the multicast-and-broadcast service respectively in each of the transmission architectures (step S305).

As shown in the equation (l) in the aforementioned embodiment, the data per symbol respectively corresponding to each of the base stations is regarded as the function of SINR respectively corresponding to each of the base stations. Thus, the determining module 804, by using table 2 which lists the SINRs respectively corresponding to the modulation levels and the coding schemes, maps the SINRs respectively corresponding to each of the base stations and obtained from the SINR calculating module 802 onto the data per symbol which can be respectively transmitted by each of the base station.

According to the data per symbol corresponding to each of the base stations as the transmission system transmits the multicast-and-broadcast service respectively in each of the transmission architectures, the spectral efficiency calculating module 806 calculates a single cell spectral efficiency of each of the base stations while the transmission system 700 transmits the multicast-and-broadcast service respectively in each of the transmission architectures (step S311). In one embodiment, under each of the transmission architectures, the spectral efficiency calculating module 806 calculates the single cell spectral efficiency DL of each of the base stations according to the equation (m) in the aforementioned embodiment.

The average-value calculating module 808 calculates the average cell spectral efficiency corresponding to each of the transmission architectures in which the transmission system respectively transmits the multicast-and-broadcast service according to the number of the base stations and the single cell spectral efficiency of each of the base stations while the transmission system transmits the multicast-and-broadcast service respectively in each of the transmission architectures (step S315).

In another embodiment, when the base station is operated in the SC-PTM communication mode or the relay-enabled SC-PTM communication mode, the calculating module 708, taking the factors including the covering range of the base station, the subscriber distribution within the covering range of the single base station, the number of the subscribers within the covering range of the base station and various coverages into account, calculates the single cell spectral efficiency DL of the base station by referring to the data per symbol of each of the subscribers respectively with various farthest distances away from the base station according to the equation (l) and using the equation (o) in the aforementioned embodiment (step S105 in the aforementioned embodiment).

When the base station is operated in the SFN communication mode or the relay-enabled SFN communication mode, the calculating module 708 calculates the SINR of the multicast-and-broadcast service received by one of the subscribers at the border of the covering range of the base station, and calculates the single cell spectral efficiency DL of the base station while the transmission system 700 transmits the multicast-and-broadcast service with one of the transmission architecture according to the SINR and the equation (m). Finally, according to the number of the base stations and the single cell spectral efficiency of each of the base stations while the transmission system transmits the multicast-and-broadcast service respectively in each of the transmission architectures, the average-value calculating module 808 of the calculating module 708 calculates the average cell spectral efficiency corresponding to each of the transmission architectures in which the transmission system 700 respectively transmits the multicast-and-broadcast service.

FIG. 9 is a schematic diagram showing a preliminary selection module in a transmission system according to one embodiment of the present invention. In the other embodiment, as shown in FIG. 9, the transmission system 700 further comprises a preliminary selection module 900 selecting a portion of the transmission architectures according to the number of the subscribers of each of the base stations. More specifically, the preliminary selection module 900 comprises a classifying module 902, a topology establishing module 904 and a topology selection module 906. The classifying module 902 of the preliminary selection module 900 classifies the communication mode of each of the base stations into communication classes including a SC-PTM communication class (including the SC-PTM communication mode and the relay-enabled SC-PTM communication mode) and a SFN communication class (including the SFN communication mode and the relay-enabled SFN communication mode) in advance according to the number of the subscribers of each of the base stations (step S401).

The topology establishing module 904 establishes a preliminary transmission topology according to the communication class of each of the base stations in the transmission system 700 (step S405). The topology selection module 706 selects the portion of the transmission architectures which are similar to the preliminary transmission topology (step S411). More specifically, when the number of the subscribers within the covering range of the base station is larger than or equal to seven, the communication mode of the base station is classified into the SFN communication class. However, when the number of the subscribers within the covering range of the base station is smaller than seven, the communication mode of the base station is classified into the SC-PTM communication class.

It should be noticed that all of the modules of the transmission system of the present invention can be implemented by a computer readable-and-writable program and the computer readable-and-writable program is executed by a processor to implement the method of selecting one of the transmission architectures for the transmission system of the present invention.

The invention provides a selection mechanism for selecting the transmission architecture for transmitting the multicast-and-broadcast service. By individually determining the communication mode of each of the base stations in the transmission system, the transmission performance of each of the base stations is improved and the whole transmission performance of the transmission system is improved as well. Moreover, by further considering the variables/factors including the coverage of each of the base stations, the covering range of each of the base stations, the subscriber distribution within the covering range of each of the base stations (probability of the distance between the subscriber and the base station) and the number of the subscribers within the covering range of each of the base stations, several equations are provided to calculate the transmission efficiency respectively corresponding to each of the transmission architectures. Thus, the transmission architecture for transmitting the multicast-and-broadcast service can be dynamically changed by selecting the one with the maximum transmission efficiency.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for a transmission system selecting one of a plurality of transmission architectures to transmit a multicast-and-broadcast service, wherein the transmission system includes at least a base station participating a transmission of the multicast-and-broadcast service, the method comprising:
calculating a number of subscribers subscribing the multicast-and-broadcast service within a covering range of each of the base stations;
according to a number of the base stations participating the transmission of the multicast-and-broadcast service, a coverage of each of the base stations, the covering range of each of the base stations, the number of the subscribers within the covering range of each of the base stations, a subscriber distribution of each of the base stations, calculating an average cell efficiency corresponding to each of the transmission architectures which are respectively used by the transmission system to transmit the multicast-and-broadcast service;
analyzing the average cell efficiency corresponding to each of the transmission architectures which are respectively used by the transmission system to transmit the multicast-and-broadcast service; and
selecting the transmission architecture corresponding to the maximum average cell efficiency for the transmission system transmitting the multicast-and-broadcast service.

2. The method of claim 1, wherein the average cell efficiency corresponding to each of the transmission architectures comprises an average cell information or an average cell spectral efficiency.

3. The method of claim 2, wherein when the average cell efficiency corresponding to each of the transmission architectures is the average cell spectral efficiency, the step of calculating an average cell efficiency corresponding to each of the transmission architectures which are respectively used by the transmission system to transmit the multicast-and-broadcast service comprises:
calculating a plurality of signal-to-interference-and-noise ratios (SINRs) corresponding to each of the base stations while the transmission system transmits the multicast-and-broadcast service respectively in each of the transmission architectures;
according to the SINRs, determining a data per symbol corresponding to each of the base stations while the transmission system transmits the multicast-and-broadcast service respectively in each of the transmission architectures;
according to the data per symbol corresponding to each of the base stations as the transmission system transmits the multicast-and-broadcast service respectively in each of the transmission architectures, calculating a single cell spectral efficiency of each of the base stations while the transmission system transmits the multicast-and-broadcast service respectively in each of the transmission architectures; and
according to the number of the base stations and the single cell spectral efficiency of each of the base stations while the transmission system transmits the multicast-and-broadcast service respectively in each of the transmission architectures, calculating the average cell spectral efficiency corresponding to each of the transmission architectures in which the transmission system transmits the multicast-and-broadcast service respectively.

4. The method of claim 1, wherein each of the transmission architectures is selected from a group comprised of a single-cell point-to-multipoint (SC-PTM) communication mode, a relay-enabled single-cell point-to-multipoint (relay-enabled SC-PTM) communication mode, a single frequency network (SFN) communication mode, a relay-enabled single frequency network (relay-enabled SFN) communication mode or the combination thereof.

5. The method of claim 1, after the step of calculating the number of the subscribers and before the step of calculating the average cell efficiency corresponding to each of the transmission architectures which are respectively used by the transmission system to transmit the multicast-and-broadcast service, further comprising:
performing a preliminary selection, according to the number of the subscribers of each of the base stations, to select a portion of the transmission architectures, wherein, in the step of calculating the average cell efficiency, the average cell efficiency corresponding to each of the selected transmission architectures which are respectively used by the transmission system to transmit the multicast-and-broadcast service are calculated.

6. The method of claim 5, wherein the preliminary selection comprises:
according to the number of the subscribers of each of the base stations, classifying a communication mode of each of the base stations into communication classes including a SC-PTM communication class and a SFN communication class; and
according to a preliminary transmission topology established by the communication class of each of the base stations in the transmission system, selecting the portion of the transmission architectures which are similar to the preliminary transmission topology.

7. A transmission system for transmitting a multicast-and-broadcast service, the transmission system comprising:
at least a base station participating a transmission of the multicast-and-broadcast service;
a recording module recording a number of subscribers subscribing the multicast-and-broadcast service within a covering range of each of the base stations;
a calculating module calculating an average cell efficiency corresponding to each of the transmission architectures which are respectively used by the transmission system to transmit the multicast-and-broadcast service according to a number of the base stations participating the transmission of the multicast-and-broadcast service, a coverage of each of the base stations, the covering range of each of the base stations, the number of the subscribers within the covering range of each of the base stations, a subscriber distribution of each of the base stations;
an analyzing module analyzing the average cell efficiency corresponding to each of the transmission architectures which are respectively used by the transmission system to transmit the multicast-and-broadcast service; and
a selecting module selecting the transmission architecture corresponding to the maximum average cell efficiency for the transmission system transmitting the multicast-and-broadcast service.

8. The transmission system of claim 7, wherein the average cell efficiency corresponding to each of the transmission architectures comprises an average cell information or an average cell spectral efficiency.

9. The transmission system of claim 8, wherein when the average cell efficiency corresponding to each of the transmission architectures is the average cell spectral efficiency, the calculating module comprises:
an SINR calculating module calculating a plurality of signal-to-interference-and-noise ratios (SINRs) corresponding to each of the base stations while the transmission system transmits the multicast-and-broadcast service respectively in each of the transmission architectures;
a determining module determining a data per symbol corresponding to each of the base stations according to the SINRs while the transmission system transmits the multicast-and-broadcast service respectively in each of the transmission architectures;
a spectral efficiency calculating module calculating a single cell spectral efficiency of each of the base stations while the transmission system transmits the multicast-and-broadcast service respectively in each of the transmission architectures according to the data per symbol corresponding to each of the base stations as the transmission system transmits the multicast-and-broadcast service respectively in each of the transmission architectures; and
an average-value calculating module calculating the average cell spectral efficiency corresponding to each of the transmission architectures in which the transmission system respectively transmits the multicast-and-broadcast service according to the number of the base stations and the single cell spectral efficiency of each of the base stations while the transmission system transmits the multicast-and-broadcast service respectively in each of the transmission architectures.

10. The transmission system of claim 7, wherein each of the transmission architectures is selected from a group comprised of a single-cell point-to-multipoint (SC-PTM) communication mode, a relay-enabled single-cell point-to-multipoint (relay-enabled SC-PTM) communication mode, a single frequency network (SFN) communication mode, a relay-enabled single frequency network (relay-enabled SFN) communication mode or the combination thereof.

11. The transmission system of claim 7 further comprising:
a preliminary selection module selecting a portion of the transmission architectures according to the number of the subscribers of each of the base stations.

12. The transmission system of claim 11, wherein the preliminary selection module comprises:
a classifying module classifying a communication mode of each of the base stations into communication classes including a SC-PTM communication class and a SFN communication class according to the number of the subscribers of each of the base stations;
a topology establishing module establishing a preliminary transmission topology according to the communication class of each of the base stations in the transmission system; and
a topology selection module selecting the portion of the transmission architectures which are similar to the preliminary transmission topology.
